(19) United States
(12) Patent Application Publication
(10) Pub. No.: US 2018/0274578 A1
(43) Pub. Date: Sep. 27, 2018

(54) JOINING SYSTEM AND METHOD

(71) Applicant: GM GLOBAL TECHNOLOGY OPERATIONS LLC, Detroit, MI (US)

(72) Inventors: PEI-CHUNG WANG, TROY, MI (US); BRADLEY J. BLASKI, STERLING HEIGHTS, MI (US); RICHARD C. JANIS, GROSSE POINTE WOODS, MI (US)

(73) Assignee: GM GLOBAL TECHNOLOGY OPERATIONS LLC, Detroit, MI (US)

(21) Appl. No.: 15/467,883

(22) Filed: Mar. 23, 2017

(51) Int. Cl. F16B 21/20; F16B 5/00; F16B 19/00

(52) U.S. Cl. CPC F16B 21/20; F16B 19/00; F16B 5/00

(57) ABSTRACT

Systems and method are provided for joining components. A pin may have a head, and a stem extending from the head. The stem may have a tapered section. A collar may have a shank with a through-hole. Another tapered section may be formed by the shank so that a tapered surface of the tapered section faces into the through-hole. The pin and the collar may be configured so that the stem is received in the through-hole. The tapered sections mate together, and the tapered surface contacts the tapered section of the stem.

### TECHNICAL FIELD

The present disclosure generally relates to joining systems, and more particularly relates to joining systems and methods applicable to joining polymeric composites.

### INTRODUCTION

Manufactured products are typically assembled from a number of elements that are integrated into a product. The individual elements may be engaged in a number of fashions, one of which involves being joined together. The options for joining elements together are copious. However, the challenges in joining parts of an assembly, and in joining different types of materials are endless, and so the need persists for new and effective devices and methods of joining.

Accordingly, it is desirable to provide new systems and methods for joining components. Furthermore, other desirable features and characteristics of the present disclosure will become apparent from the subsequent detailed description and the appended claims, taken in conjunction with the accompanying drawings and the foregoing technical field and background.

### SUMMARY

Systems and methods are provided for joining components. In a number of examples, a pin may have a head, with a stem extending from the head. The stem may have a tapered section. A collar may have a shank with a through-hole. Another tapered section may be formed by the shank so that a tapered surface of the tapered section faces into the through-hole. The pin and the collar may be configured so that the stem is received in the through-hole. The tapered sections mate together, and the tapered surface contacts the tapered section of the stem.

In additional examples, a pin may be provided and may have a head, a stem extending from the head, and a first a tapered section on the stem. A collar may be provided, and may have a shank, with a through-hole defined through the collar including through the shank. A second tapered section may be formed by the shank so that a tapered surface faces into the through-hole. The stem may be received in the through-hole with the tapered sections mating together so that the tapered surface contacts the tapered section of the stem.

In a number of other examples, a joining system may include a pin that has a head and a stem extending from the head. The stem may have a proximal end joining with the head and a distal end opposite the proximal end. A first section may extend from the proximal end toward the distal end, and may be cylindrical in shape. A first tapered section may extend from the first section toward the distal end. A second section may extend from the tapered section toward the distal end. The second section may have a smaller diameter than the first section. A collar may have a first end and a second end opposite the first end. A shank may extend from the first end toward the second end. A cap may be disposed between the shank and the second end. The cap may extend radially outward from the shank. A crown may extend from the cap to the second end, and may be shaped as a hollow cylinder. A second tapered section may be formed by the shank, and may have a tapered surface that faces toward the pin. The pin and the collar may be configured so that the stem is received in the collar, with the first and second tapered sections mating together, and with the tapered surface contacting the first tapered section.

### BRIEF DESCRIPTION OF THE DRAWINGS

The exemplary embodiments will hereinafter be described in conjunction with the following drawing figures, wherein like numerals denote like elements, and wherein:

FIG. 1 is a cross sectional illustration of a joining system, in accordance with various embodiments;

FIG. 2 is a cross sectional illustration of part of the joining system if FIG. 1, in accordance with various embodiments, taken generally along the line 2-2 as indicated in FIG. 3;

FIG. 3 is an illustration of part of the joining system of FIG. 1, in accordance with various embodiments;

FIG. 4 is a cross sectional illustration of part of the joining system of FIG. 1, in accordance with various embodiments, taken generally along the line 4-4 indicated in FIG. 5;

FIG. 5 is an illustration of part of the joining system of FIG. 1, in accordance with various embodiments

FIG. 6 is a cross sectional illustration of part of the joining system of FIG. 1, employing methods in accordance with various embodiments;

FIG. 7 is a cross sectional illustration of part of the joining system of FIG. 1, employing methods in accordance with various embodiments;

FIG. 8 is a cross sectional illustration of the joining system of FIG. 1, employing methods in accordance with various embodiments;

FIG. 9 is a cross sectional illustration of the joining system of FIG. 1, employing methods in accordance with various embodiments.

FIG. 10 is a cross sectional illustration of the joining system of FIG. 1, employing methods in accordance with various embodiments.

### DETAILED DESCRIPTION

The following detailed description is merely exemplary in nature and is not intended to limit the application or its uses. Furthermore, there is no intention to be bound by any expressed or implied theory presented in the preceding technical field, introduction, brief summary or the following detailed description.

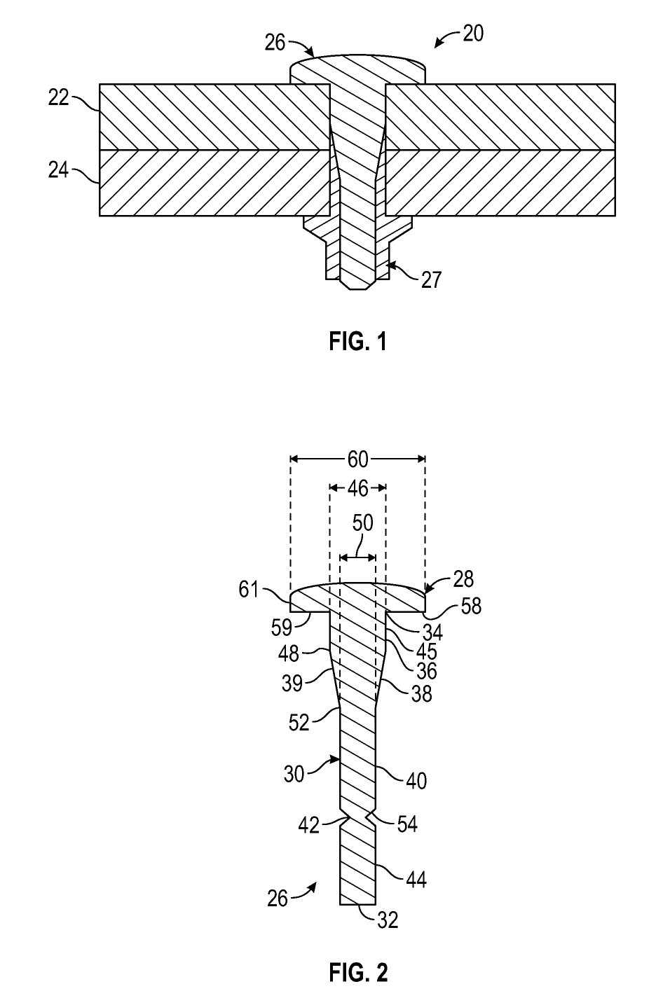

In product assembly, challenges in efficient joining of components may be compounded when alternative materials used. One such application may involve polymeric composite sheet components, which may be positioned together with overlapping edges that are in need of being secured. To successfully connect such elements, a joining system 20 is provided as illustrated in FIG. 1, according to various examples. With reference to FIG. 1, the joining system 20 is provided for maintaining a fixed relative position of two or more components 22, 24. While referred to as components 22, 24, it should be noted that the joining system 20 is not limited to applications involving separate parts, but is also applicable to joining two or more parts of a single structure. Accordingly, the term components is used in reference to multiple parts, whether separated or contiguous. The components 22, 24 may be any elements for which joining together is desired, and may be constructed from any material. In the present example, one or both of the components 22, 24 may be constructed from a light-weight material, such as a polymeric composite material. These materials may be used as an alternative to steel. In various examples the joining system 20 securely joins such materials while minimizing deformation, avoiding material separation, and/or avoiding localized stress concentration. The joining system 20 of the present example generally includes a pin 26 and a collar 27, which cooperate to secure the components 22 and 24 together. The pin 26 and/or the collar 27 may be fabricated of any number of materials, including but not limited to: plastic, composite, metal (e.g. stainless steel, mild steel, etc.), or metal with polymer or ceramic coating for galvanic corrosion protection.

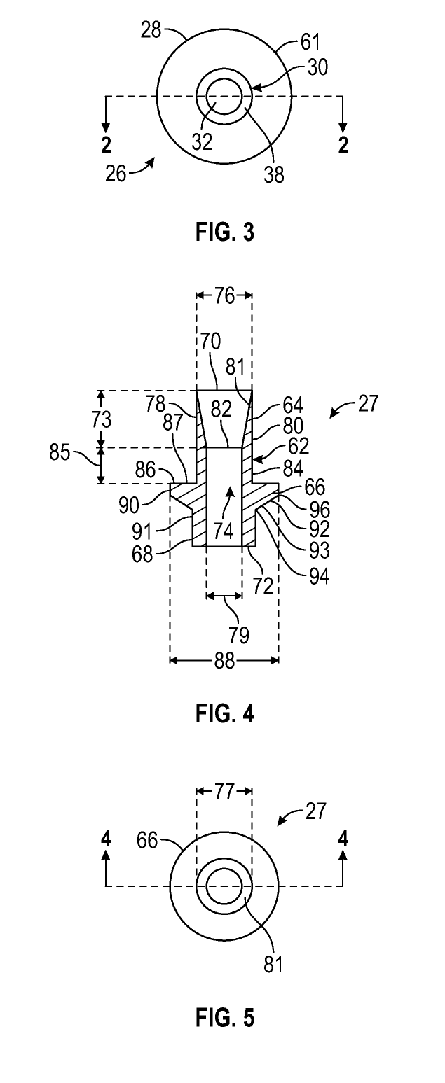

In various examples as illustrated in FIGS. 2 and 3, the pin 26 includes a head 28 and a stem 30 extending from the head 28. FIG. 2 shows the pin 26 in a longitudinal cross section view, and FIG. 3 shows the pin 26 as viewed from its distal end 32 opposite the head 28. The stem 30 is an elongated element that has a proximal end 34 joining with the head 28, and extends to the distal end 32, opposite the proximal end 34. As viewed in FIG. 3, the stem 30 has circular cross sections that change along its length. The stem 30 has a section 36 beginning at the proximal end 34 and extending partly along the stem 30 toward the distal end 32. The section 36 is solid and generally cylindrical in shape, with an outer perimeter 45 defining a diameter 46 that is consistent along the length of the section 36. The stem 30 has a tapered section 38 that extends from the section 36 partly along the stem 30 toward the distal end 32. The tapered section 38 narrows, tapering down consistently from its end 48 to its end 52 forming a surface 39 facing outward around the stem 30. The tapered section 38 has the diameter 46 at its end 48 and a smaller diameter 50 at its end 52. A section 40 of the stem 30 extends from the end 52 to an end 54, so that the section 40 extends partly along the stem 30 from the tapered section 38 toward the distal end 32. The section 40 has the diameter 50, consistently along its length. The diameter 50 is smaller than the diameter 46; hence, the section 40 has a reduced diameter relative to the section 36. Adjacent the end 54, the stem 30 has a narrowed section 42 that has a diameter smaller than the diameter 50, which creates a weakened point along the stem 30. A section 44 extends between the narrowed section 42 and the distal end 32. The section 44 has the diameter 50 substantially consistently along its length.

In various examples, the pin 26 includes the head 28, which extends radially outward from the stem 30 creating a shoulder 58, with a surface 59, which is annular and faces generally in the direction of the distal end 32. The head 28 has and outer perimeter 61 defining a diameter 60 that is larger than the diameter 46. In some examples, the diameter 60 may be approximately twice as large as the diameter 46. The relative diameter size provides a broad shoulder 58 for mating with the components 22, 24. The head 28 has a relatively low profile in this example, and may vary depending on the application, or on the type of tool that may be used in applying it in a joining process.

In various examples, the collar 27 as illustrated in FIGS. 4 and 5, generally includes a body 62, with a shank 64, a cap 66, and a crown 68. The body 62 includes an insertion end 70 and a crown end 72. The body 62 has a through-hole 74 extending through the body 62 from the insertion end 70 to the crown end 72. The shank 64 starts at the insertion end 70 and extends along part of the body 62 to the cap 66. The shank 64 has an outer diameter 76 that is consistent along its length from the insertion end 70 to the cap 66, defining a cylindrically shaped outer surface 78. The through-hole 74 extends through the shank 64 and is partly defined by a tapered section 80 of the shank 64, which extends a distance 73 from the insertion end 70 to an interior end 82 of the tapered section 80. The tapered section 80 is formed so that the through-hole 74 narrows, tapering down consistently from the insertion end 70 to the interior end 82. The through-hole 74 tapers through the tapered section 80 from a diameter 77 to a diameter 79 and forms a tapered surface 81 of the collar 27 facing inward within the through-hole 74. The diameter 77 is larger than the diameter 79 and is approximately equal to the diameter 76. The shank 64 includes a section 84 that extends a length 85 from the interior end 82 to the cap 66. The section 84 comprises a hollow cylindrical shape along its entire length, with the through-hole 74 extending through the section 84. The cap 66 projects radially outward from the section 84 creating a shoulder 86, with a surface 87, which is annular and faces generally in the direction of the insertion end 70. The cap 66 has an outermost diameter 88 at its periphery that is larger than the diameter 76. In the current embodiment, the diameter 88 is comparable to the diameter 60 of the pin 26 so that surface deformation of the components 22, 24 at the head 28 and the cap 66, is balanced. The cap 66 includes a section 90 that comprises a hollow cylinder along its entire length with the through-hole 74 extending through the section 90. Extending from the section 90 toward the crown end 72, the cap 66 has a tapered section 92 with an outer surface 93 that tapers from end 94 to end 96. The surface 93 tapers consistently outward from the end 94 to the end 96, which provides strength for the shoulder 90 and the convenient surface 93 to interface with assembly machinery. The crown 68 extends from the cap 66 to the crown end 72. The crown 68 includes a section 91 that comprises a hollow cylinder along its entire length with the through-hole 74 extending through the section 91.

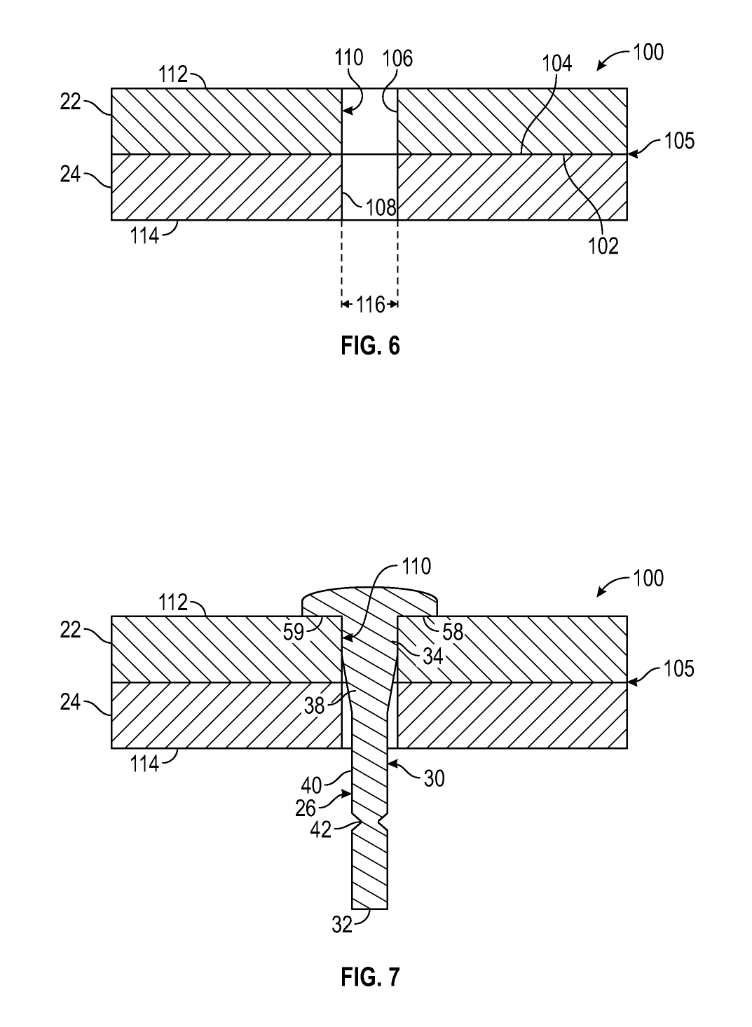

In various examples, a process 100 with various joining methods is illustrated in FIGS. 6-10. As shown in FIG. 6, the components 22, 24 may be brought together and placed so that they overlap with a surface 102 of the component 22 mating with a surface 104 of the component 24 at an interface 105. The mating surfaces 102, 104 may encompass only a part of the components 22, 24, which may extend apart from one another in any direction. In some examples the surfaces 102, 104 may not mate in their entirety, or may be spaced apart from one another. An aperture 110 is formed completely through the components 22, 24 from an outer surface 112 to an outer surface 114. The aperture 110 is formed by openings 106 and 108, which are formed through the components 22, 24 respectively, and which are aligned with one another. The openings 106 and 108 provide the same, or substantially the same open diameter 116. The openings 106, 108 may be formed independently, or during a common operation, and in either case such as by boring, stamping, piercing, or through another forming operation. Accordingly, the openings 106 and 108 are aligned with one another, presenting a consistent aperture 110 through the overlapping components 22, 24.

With reference to FIG. 7, in a number of examples, the pin 26 is applied to the components 22, 24. The stem 30 extends completely through the aperture 110 with the distal end 32 projecting outward and away from the surface 114. The shoulder 58 is positioned over the component 22 so that the surface 59 contacts and mates with the surface 112. The section 34 of the stem 30, is positioned in the opening 106 and may fit closely therein with minimal or no clearance. The tapered section 38 spans across the interface 105 extending into both the opening 106 and the opening 108. This location places the tapered section 38 at an inward position in the aperture 110 away from both surfaces 112, 114, and ensures it extends into the component 22. The section 40 extends through part of the opening 108 and projects out of the aperture 110 from the surface 114. The distal end 32 and the narrowed section 42 are presented outside the aperture 110.

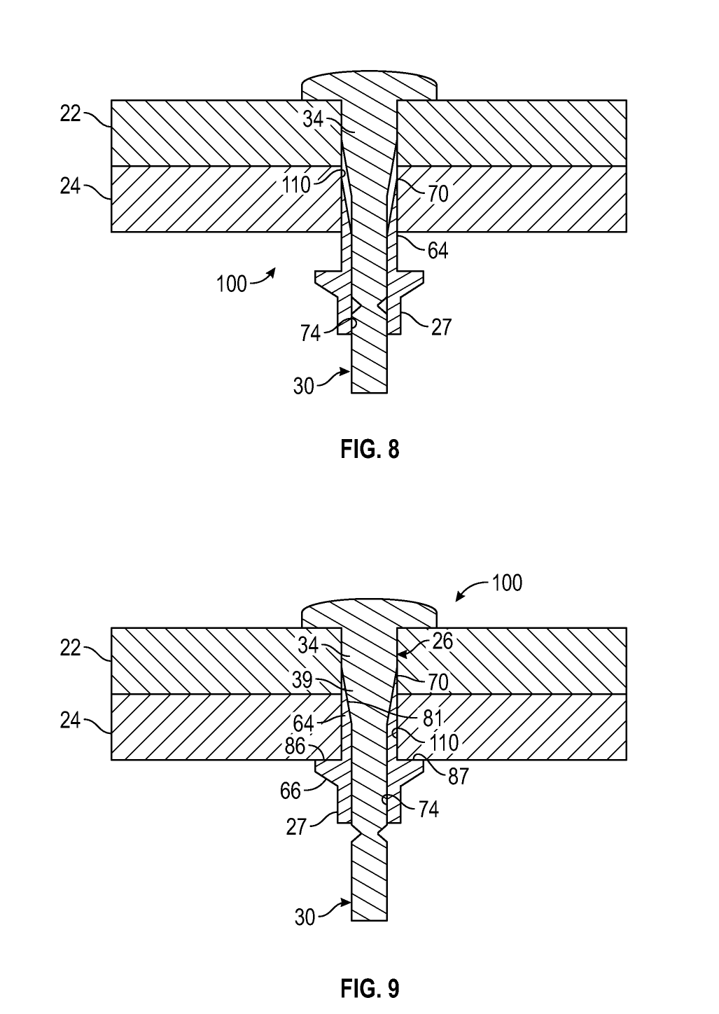

In a number of examples as illustrated in FIGS. 8 and 9, the collar 27 is applied to the components 22, 24 with the insertion end 70 inserted into the aperture 110 and the stem 30 received within the through hole 74. FIG. 8 shows the collar 27 in the process of insertion and FIG. 9 shows the collar 27 fully inserted. The shank 64 of the collar 27, and the section 34 of the stem 30 substantially fill the aperture 110 when the collar 27 is fully inserted as shown in FIG. 9. A close fit, with little or no clearance between the shank 64 and the components 22, 24 within the aperture 110, provides strength. The cap 66 is positioned in FIG. 9 so that the shoulder 86 extends over the component 24 with the surface 87 facing the surface 114. The surface 39 of the stem 30 contacts and mates with the tapered surface 81 of the collar 27. Contact between the surfaces 39 and 81 aligns the pin 26 and the collar 27, both relative to each other, and within the aperture 110. The mating contact also provides stability of the assembled pin 26 and collar 27, for strength.

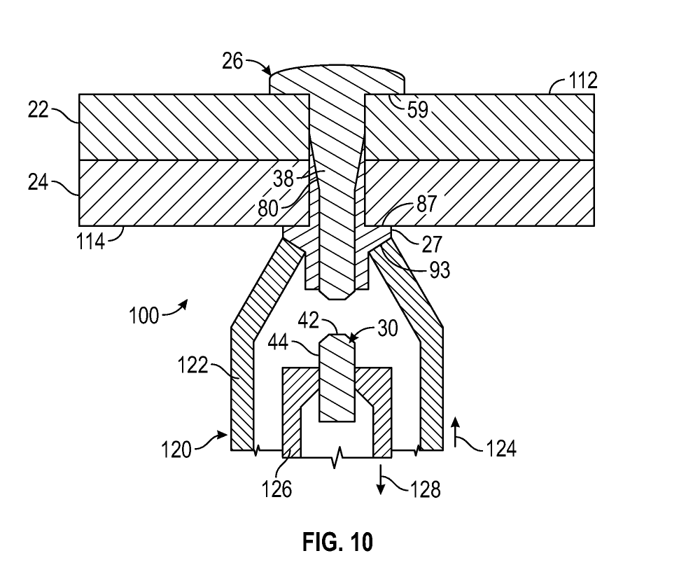

In a number of examples as shown in FIG. 10, machinery 120 may be used to secure the assembly. The machinery 120 includes a first element 122 that contacts the collar 27 at surface 93 and applies a force 124 to fully seat the collar 27. The machinery 120 includes a second element 126 that contacts the stem 30 and grasps the section 44 outward from the narrowed section 42. The second element 126 applies a second force 128 fully seating the pin 26 and breaking the section 44 away from the pin 26 at the narrowed section 42. The surface 59 is forced against the surface 112, and the surface 87 is forced against the surface 114 securing the components 22, 24 together. The tapered section 38 of the pin 26 interacts with the tapered section 80 of the collar 27 to inhibit compression of the components 22, 24, while affecting a secure joined assembly 130. The pin 26 and the collar 27 may be secured through a press fit. In a number of examples, the pin 26 and/or the collar 27 may be provided with ridges or other features (not shown), for added retention. For example, the machinery 120 may apply a force to swage the collar 27 to a serrated stem 30. As a result, the workpieces 22 and 24 are securely tightened by the cap 26 and collar 27. The process 100 provides a robust joining solution and may open new design space by allowing the use of alternative materials such as polymeric composites, to achieve weight reduction, performance and corrosion resistance improvement.

In a number of examples, the pin 26 or the stem 30 thereof, may be fabricated from a shape memory alloy. A shape memory alloy stem 30 may remember an original shape and when deformed, such as under the operation of the machinery 120, later returns to its pre-deformed shape. The application of heat may be used to return the pin 26 to its original shape. The use of a shape memory alloy may apply a load between the head 28 and the cap 66 that may be tailored to the application. Accordingly, the process 100 may include determining an amount of load for joining the components 22, 24, forming the pin 26 with a shape memory alloy material to provide that load, and heating the pin 26 to return it to an original shape after breaking away the section 44.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A joining system for joining components together comprising:
a pin that has a head, with a stem extending from the head, wherein the stem has a first tapered section;
a collar that has a shank, with a through-hole defined through the collar, including through the shank;
a second tapered section formed by the shank so that a tapered surface of the second tapered section faces into the through-hole; and
wherein the pin and the collar are configured so that the stem in received in the through-hole with the first and second tapered sections mating together, wherein the tapered surface contacts the first tapered section.

2. The joining system of claim 1 wherein:
the components define an aperture extending completely through the components;
the stem extends into the aperture; and
the shank extends into the aperture with the tapered surface disposed entirely with the aperture.

3. The joining system of claim 2 wherein:
the components comprise first and second components that contact one another at an interface;
wherein the through-hole extends across the interface; and
wherein the tapered surface extends across the interface.

4. The joining system of claim 2 wherein:
the pin has a head extending outward from the stem and extending over the components;
wherein the head has a first outer perimeter that defines a first diameter;
wherein the collar comprises a cap that has a second outer perimeter that defines a second diameter; and
wherein the first diameter is approximately twice the second diameter in size.

5. The joining system of claim 1 wherein the pin comprises:
a proximal end joining with the head;
a distal end opposite the proximal end;
a first section extending from the proximal end toward the distal end, the first section cylindrical in shape;
wherein the tapered section extends from the first section toward the distal end;
a second section extending from the tapered section toward the distal end, wherein the second section has a smaller diameter than the first section; and
a narrowed section adjacent the second section that is narrower compared to the second section.

6. The joining system of claim 1 wherein the collar comprises:
a first end;
a second end opposite the first end, wherein the shank extends from the first end toward the second end;
a cap disposed between the shank and the second end, the cap extending radially outward from the shank; and
a crown extending from the cap to the second end, the crown comprising a hollow cylinder.

7. The joining system of claim 1 wherein:
the components comprise a first component and a second component, and define an aperture extending through both the first and second components;
the stem extends through the aperture;
the stem has a first section extending between the head and the tapered section, the first section cylindrical in shape and extending into the first component;
the tapered section is disposed in the aperture and extends into both the first and second components;
the shank extends into the aperture and is disposed around the stem; and
the tapered surface contacts the first tapered section within the first component and within the second component.

8. The joining system of claim 1 wherein:
the collar includes a cap extending radially outward from the shank, the cap defines a shoulder with an annular surface facing toward the head, and the cap defines an outer surface that tapers and faces away from the head.

9. A method to join components together comprising:
providing a pin that has a head, a stem extending from the head, and a first tapered section on the stem;
providing a collar that has a shank with a through-hole defined through the collar including through the shank;
providing a second tapered section formed by the shank so that a tapered surface of the tapered section faces into the through-hole; and
received the stem in the through-hole with the first and second tapered sections mating together so that the tapered surface contacts the first tapered section.

10. The method of claim 9 comprising:
providing a cap on the collar;
forcing the head and the cap against the components; and
aligning the pin and the collar through the tapered surface.

11. The method of claim 9 comprising:
providing an insertion end on the collar;
forming the tapered surface to extend to the insertion end;
inserting the collar into the components leading with the insertion end; and
receiving the first tapered section into the second tapered section.

12. The method of claim 9 comprising:
providing a cap on the collar;
forcing a first machinery element against the cap;
grasping the stem with a second machinery element; and
compressing the components between the head and the cap.

13. The method of claim 9 comprising:
providing the components as a first component and a second component;
forming an aperture through the components by forming a first opening in the first component and forming a second opening in the second component;
aligning the first and second openings: and
filling the first and second openings with the stem and the shank.

14. The method of claim 13 comprising:
positioning the first and second tapered sections so that they extend into both the first opening and the second opening.

15. The method of claim 9 comprising:
forming a cap on the collar;
forming the tapered surface so that it extends along the through-hole to an end; and
forming a cylindrical shaped section of the collar from the end to the cap.

16. A joining system for joining components together comprising:
a pin that has a head and a stem extending from the head, wherein the stem has a proximal end joining with the head and a distal end opposite the proximal end;
a first section extending from the proximal end toward the distal end, the first section cylindrical in shape;
a first tapered section extending from the first section toward the distal end;
a second section extending from the first tapered section toward the distal end, wherein the second section has a smaller diameter than the first section;
a collar that has a first end and a second end opposite the first end;
a shank extending from the first end toward the second end;
a cap disposed between the shank and the second end, the cap extending radially outward from the shank;
a crown extending from the cap to the second end, the crown comprising a hollow cylinder;
a second tapered section formed by the shank with a tapered surface that faces toward the pin; and
wherein the pin and the collar are configured so that the stem in received in the collar, with the first and second tapered sections mating together, and the tapered surface contacts the first tapered section.

17. The joining system of claim 16 wherein:
the components comprise a first component and a second component, and define an aperture extending through both the first and second components;
the stem extends through the aperture;
the tapered section is disposed in the aperture and extends into both the first and second components;
the shank extends into the aperture and around the stem; and
the tapered surface contacts the first tapered section within the first component and within the second component.

18. The joining system of claim 17 wherein:
the first and second components contact one another at an interface;
wherein a through-hole is defined through the collar and the through-hole extends across the interface; and
wherein the tapered surface extends across the interface.

19. The joining system of claim 18 wherein:
the tapered surface extends along the through-hole to an interior end; and
a cylindrical shaped section of the collar extends from the interior end to the cap.

20. The joining system of claim 16 wherein:
the components define an aperture into which the stem and collar extend, wherein the first section and the shank fill the aperture.
